(19) United States
(12) Patent Application Publication
(10) Pub. No.: US 2006/0056822 A1
(43) Pub. Date: Mar. 16, 2006

(54) Brushless direct current motor and driver thereof

(75) Inventors: Lee-Long Chen, Taoyuan Hsien (TW); Shih-Ming Huang, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/211,588

(22) Filed: Aug. 26, 2005

(30) Foreign Application Priority Data
Aug. 27, 2004 (TW) 093125758

(51) Int. Cl. H02K 7/00; H02K 21/00; H02P 7/285

(52) U.S. Cl. 388/830; 310/181; 310/67 R

(57) ABSTRACT

A brushless direct current motor. The brushless direct current motor comprises a rotor, a stator, and a driver. The rotor comprises magnetic poles. The stator is enclosed by or enclosing the rotor. The stator comprises salient poles and at least one permanent magnetic element. The salient poles correspond to the magnetic poles, and the permanent magnetic element is disposed on one of the salient poles to facilitate the rotation of the rotor. The driver is coupled to the stator and produces a primary magnetic field on the salient poles. The rotor is rotated by a secondary salient pole induced by the permanent magnetic element and the primary magnetic field alternately.

### BACKGROUND

The present invention relates in general to a brushless direct current motor and in particular to a brushless direct current motor having permanent magnetic elements disposed on a stator and located at an inner side of the rotor.

FIG. 1 shows a conventional brushless Direct current motor disclosed in U.S. Pat. No. 6,013,966. A stator of the brushless direct current motor has a first stator yoke 10, a second stator yoke 20 (under the first stator yoke 10) and a coil around an axis therebetween, which is an axial stator. When a current is applied on the coil, salient poles 1 generate induced magnetic force to rotate a rotor 2.

The conventional brushless Direct current motor further includes two permanent magnets 3, disposed outside the rotor 2 to control a starting position of the rotor 2 and provide a starting torque.

To provide sufficient starting torque, the permanent magnets 3 must be fixed and maintained at an angle θ to the stator. The permanent magnets 3 are, however, fixed outside the rotor 2, hence, the rotor 2 and the permanent magnets 3 must be enclosed by a non-magnetically permeable cover, for example, a plastic cover, to prevent the magnetic field between the cover and the permanent magnets 3 from decreasing the positioning accuracy of the rotor 2.

When the rotor 2 is enclosed by a non-magnetically permeable cover, however, instead of a magnetically permeable cover, the torque of the rotor 2 and the magnetic force between the rotor 2 and the stator 1 is decreased.

### SUMMARY

A brushless direct current motor comprises a rotor, a stator, and a driver. The rotor comprises magnetic poles. The stator is enclosed by or encloses the rotor. The stator comprises salient poles and at least one permanent magnetic element. The salient poles correspond to the magnetic poles, and the permanent magnetic element is disposed on at least one of the salient poles to facilitate the rotation of the rotor. The driver is coupled to the stator and produces a primary magnetic field on the salient poles. The rotor is rotated by a secondary salient pole induced by the permanent magnetic element and the primary magnetic field alternately.

The permanent magnetic element is disposed on the stator and located at an inner side of the rotor. Thus, the rotor can be enclosed by a magnetically permeable cover. Additionally, the driver stops the primary magnetic field automatically when the rotor is blocked.

The invention further relates to a driver for a brushless direct current motor which comprises a primary magnetic field and an auxiliary magnetic field. The driver comprises a first coil, a start-up device and a control device. The first coil is around the stator, wherein an induced signal is produced on the first coil from a rotation of the rotor. The start-up device provides a start-up signal when the driver receives a power. The control device is coupled to the first coil and the start-up device for receiving the start-up signal and the induced signal, wherein the control device determines whether to produce the primary magnetic field according to the induced signal and the start-up signal.

### BRIEF DESCRIPTION OF THE DRAWINGS

The invention will become more fully understood from the following detailed description and the accompanying drawings, given by the way of illustration only and thus not intended to limit the disclosure.

FIG. 1 shows a conventional brushless direct current motor;

FIG. 2A shows the first embodiment of the brushless direct current motor;

FIG. 2B shows a variation of the first embodiment of the brushless direct current motor;

FIG. 3 shows an embodiment of the salient pole;

FIGS. 4a-4c show the stators and the auxiliary poles of variations of the first embodiment;

FIG. 5 shows the second embodiment of the brushless direct current motor;

FIGS. 6A-6F show variations of the second embodiment;

FIG. 7 shows a driver of the brushless direct current motor;

FIG. 8 shows the rotation data produced by the brushless direct current motor.

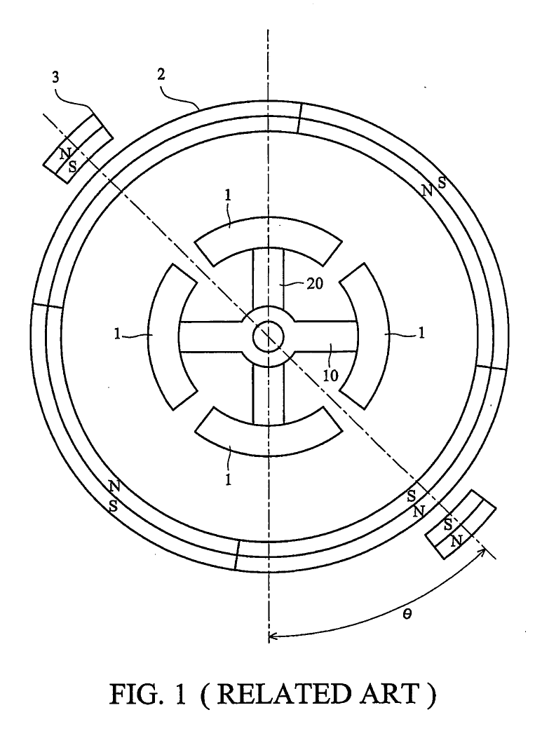

### DETAILED DESCRIPTION

Stator structures will be described in greater detail in the following.

In an exemplary embodiment of a stator structure, a permanent magnet is disposed on a stator and inside a rotor to drive the rotor to rotate, thus eliminating the need for a permanent magnet to be located at a precise position.

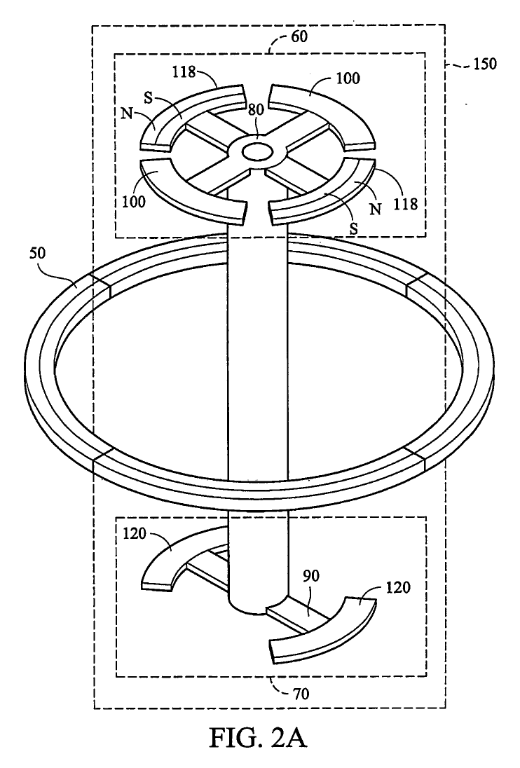

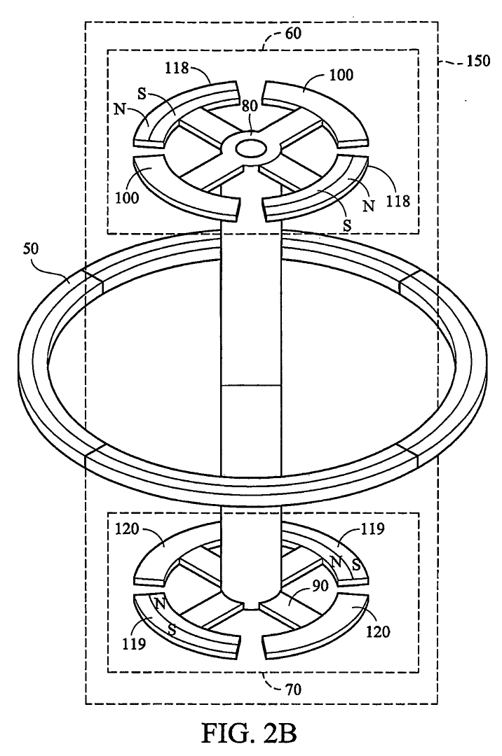

FIG. 2A shows the structure of an embodiment of a brushless direct current (DC) motor. The brushless DC motor comprises a stator 150 and a rotor 50. The rotor 50 is an annular magnet disposed around the stator 150 and coaxial with the stator 150. The stator 150 is an axial stator structure comprising an upper yoke 80 and an under yoke 90 disposed at an upper layer 60 and an under layer 70 thereof respectively. A permanent magnet 18 is symmetrically disposed between two salient poles 100 of the upper layer 60 of the stator 150. The outer layer, magnetically N-pole, of the permanent magnet 18 is an auxiliary magnetic polar layer for driving the rotor 50 to rotate.

FIG. 2B shows the structure of an embodiment of a brushless direct current (DC) motor. In this embodiment, an additional permanent magnet 19 is disposed between two salient poles 100 of the under layer 70 of the stator 150. The outer layer, magnetic S-pole, of the permanent magnet 18 is an auxiliary magnetic polar layer for driving the rotor 50 to rotate.

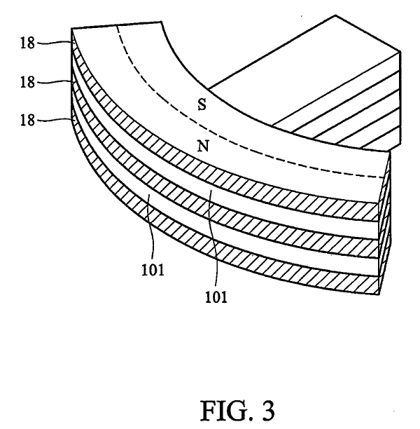

FIG. 3 shows the structure of an embodiment of a salient pole. Each salient pole, or magnetic pole, comprises a plurality of magnetic conductive layers 101. The permanent magnet 18 provides an auxiliary magnetic polar layer for the stator 150. Each permanent magnet 18 can be selectively disposed above the magnetic conductive layers 101, below the magnetic conductive layers 101, or between two magnetic conductive layers 101.

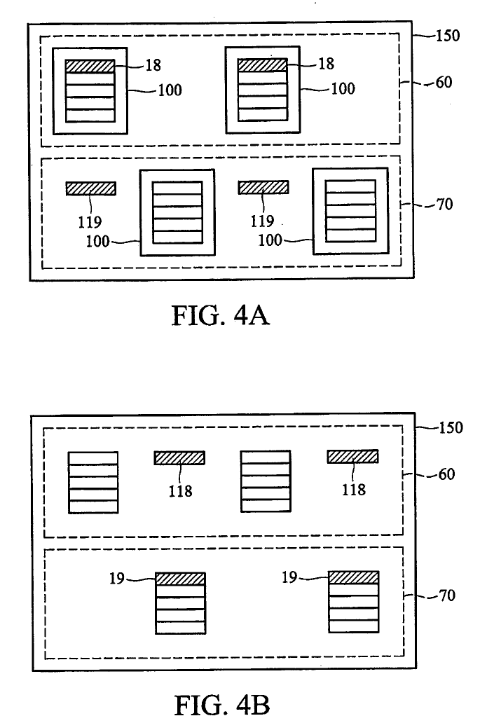

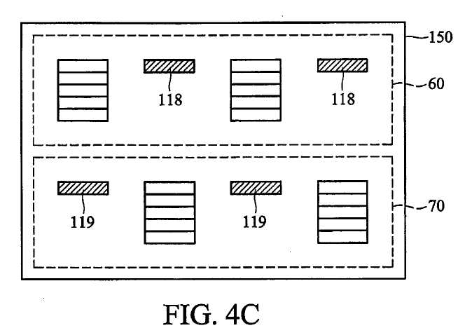

FIGS. 4A˜4C show methods for disposing an auxiliary magnetic polar layer of an embodiment of a stator structure. In FIGS. 4A and 4B, the two permanent magnets 18 and 19 are parallel and corresponding, and disposed at the upper layer 60 and the under layer 70 respectively. The outer layers of the two permanent magnets 18 and 19 are magnetically identical. For example, in FIG. 4A, the permanent magnet 18 is disposed above the salient pole 100 of the upper layer 60, and the permanent magnet 19 is disposed between the two salient poles 100 of the under layer 70. The outer layers of the two permanent magnets 18 and 19 are magnetically identical, such as N-pole or S-pole. In FIG. 4C, the two permanent magnets 18 and 19 are interlaced and disposed at the upper layer 60 and the under layer 70 respectively. The outer layers of the two permanent magnets 18 and 19 are magnetically opposite. For example, in FIG. 4C, the permanent magnet 18 is disposed between the two salient poles 100 of the upper layer 60, and the permanent magnet 19 is disposed between the two salient poles 100 of the under layer 70. The outer layers of the two permanent magnets 18 and 19 are magnetically N-pole and S-pole respectively.

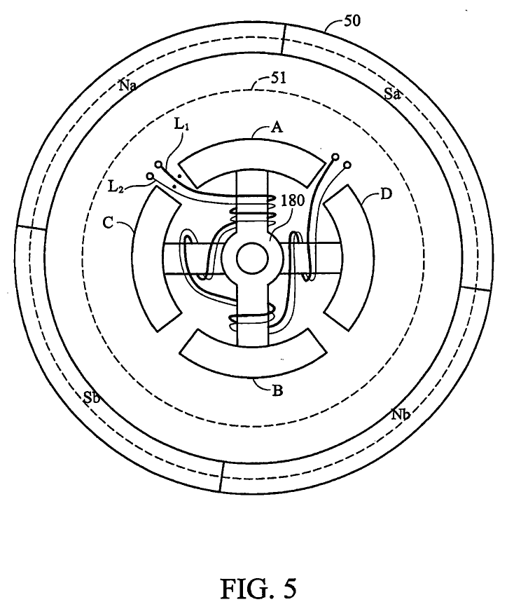

FIG. 5 shows the structure of an embodiment of a brushless direct current (DC) motor. The brushless DC motor comprises a stator comprising a yoke 180, a plurality of salient poles A, B, C, and D, and a plurality of permanent magnets 28. The stator is a radial stator structure. At least one of the permanent magnets 28 is disposed on at least one of the salient poles. For example, the permanent magnet 28 can be disposed on the salient poles C and D. The brushless DC motor further comprises a rotor 50. The rotor 50 is an annular magnet coaxially with and outside the stator, wherein poles Sa and Sb are magnetically S-pole, and poles Na and Nb are magnetically N-pole. When necessary, the rotor 50 can be disposed inside the stator.

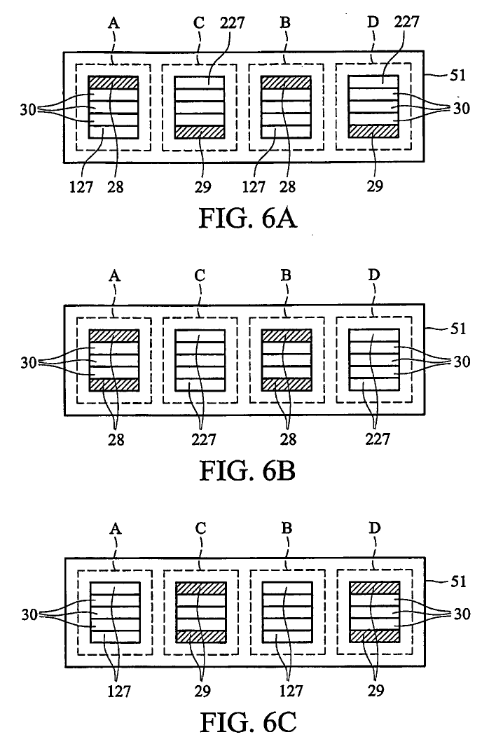

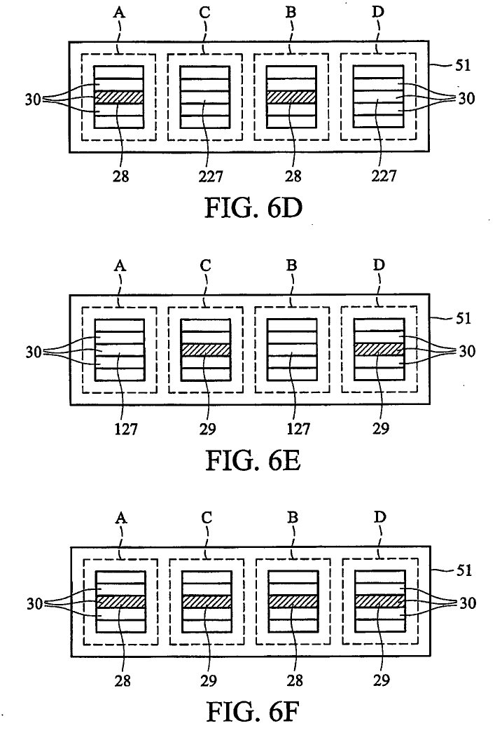

FIGS. 6A˜6F show methods for disposing an auxiliary magnetic polar layer of an embodiment of a stator structure. Outer layers of two permanent magnets on two opposite salient poles are magnetically identical, and outer layers of two permanent magnets on two adjacent salient poles are magnetically opposite. For example, in FIG. 6A, if the outer layer of the permanent magnet 28 on the salient pole A is magnetically N-pole, the outer layer of the permanent magnet 28 on the opposite salient pole B is magnetically N-pole, and the outer layers of the permanent magnet 29 on the adjacent salient poles C and D are both magnetically S-pole. In FIGS. 6A˜6F, locations 27 corresponding to the permanent magnets 28 and 29 are provided with silicon steel, ferromagnetic material, permanent magnets, soft magnetic material, plastic magnets, rubber magnets, magnet-cored plastics, or non-magnetic conductive material such as plastics. If the material at location 27 is magnetic, the material and the corresponding permanent magnet 28 or 29 are magnetically opposite. Alternatively, the corresponding locations 27 can be holes.

For example, in FIG. 6A, the stator 51 comprises magnetic poles A, B, C, and D. Each magnetic pole comprises five magnetic sub-poles. The sub-pole having the permanent magnet 28 and the sub-pole at the corresponding location 27 constitute a first auxiliary magnetic polar layer. The sub-pole having the permanent magnet 29 and the sub-pole at the corresponding location 27 constitute a second auxiliary magnetic polar layer. The middle three sub-poles of magnetic poles A, B, C, and D constitute three magnetic conductive layers. Thus, the first auxiliary magnetic polar layer is above the three magnetic conductive layers, and the second auxiliary magnetic polar layer is below the three magnetic conductive layers. Each auxiliary magnetic polar layer contains a portion of magnetic poles A, B, C, and D. Each magnetic conductive layer contains a portion of magnetic poles A, B, C, and D. Thus, the number of magnetic poles relating to the magnetic conductive layer is equal to the number of magnetic poles relating to each magnetic conductive layer.

In FIGS. 6D˜6F, the permanent magnet 28 or 29 is located at a middle sub-pole. Thus, the auxiliary magnetic polar layer is disposed between two magnetic conductive layers. The permanent magnet 28 or 29 comprises permanent magnetic material, such as a permanent magnet, a plastic magnet, a rubber magnet, or a magnet-cored plastic. The salient pole, or magnetic pole, comprises magnetic conductive material, such as ferromagnetic material or soft magnetic material.

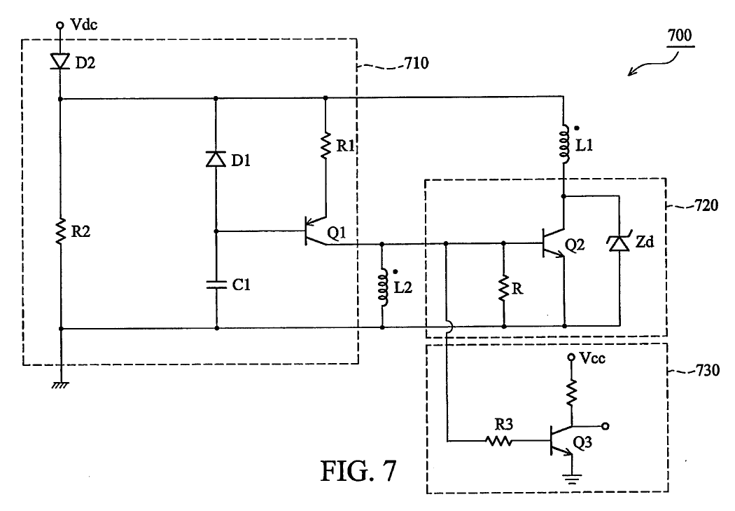

FIG. 7 shows a driver of an embodiment of a brushless DC motor. The driver 700 comprises a power coil L1, a conduction coil L2, a start-up device 710, a control device 720, and a voltage detection device 730. The driver 700 is described as below in reference to the brushless DC motor in FIG. 5. The power coil L1 in FIG. 5 and the power coil L1 in FIG. 7 are the same. The conduction coil L2 in FIG. 5 and the conduction coil L2 in FIG. 7 are the same. A diode D2 is added at a DC current input end (Vdc) to prevent reverse current. Resistors R, R1, R2, and R3 are added in the driver 700 to prevent overflow current. A Zener diode ZD is added in the control device 720 to stabilize voltage.

If the DC current Vdc is 12V, the transistor Q1 is a PNP transistor, the transistor Q2 is a NPN transistor, and the permanent magnet 28 is magnetically N-pole. When the start-up device is coupled to the DC current Vdc, the transistor Q1 is turned on due to a reverse base-emitter voltage (12V) greater than a reverse junction voltage (0.7V). When the transistor Q1 is turned on, the DC current Vdc charges the capacitor C through the current limiting resistor R1 and the transistor Q1. A start-up voltage is output from a collector of the transistor Q1. The capacitor C can be replaced by a storage circuit.

When the control device 720 receives the start-up voltage, the transistor 2 is turned on because a base-emitter forward bias is greater than a junction voltage (0.7V). Thus, a current from the start-up device 710 flows into the control device 720 through the power coil L1.

According to the right-hand principle, the direction of a current on a coil determines magnetic pole of a conducted magnetic field. Thus, the salient poles A and B of the stator are conducted to be N-pole, and the poles C and D of the stator are conducted to be S-pole. The pole Sa of the rotor 50 is attracted by the salient pole A and rejected by the salient pole D, the pole Sb thereof is attracted by the salient pole B and rejected by the salient pole C, thereby driving the rotor 50 to rotate.

When the control device 720 is continuously coupled to the DC current Vdc, the control device 720 determine whether the start-up device should stop output of a start-up signal according to electric power stored in the capacitor C.

In FIG. 7, when a voltage level of the capacitor C increases, the reverse base-emitter voltage of the transistor Q1 decreases. When the reverse base-emitter voltage thereof is below the junction voltage (0.7V), the transistor Q1 is turned off, thereby stopping output of the start-up voltage. Thus, the transistor Q2 is turned off, and no current flows through the power coil L1. The conducted magnetic field of the stator disappears, and the rotor 50 rotates by a particular angle, which is 90 degree counterclockwise in this example.

In first state, the permanent magnets 28 on the salient poles C and D attract poles Sa and Sb of the rotor 50 respectively to drive the rotor 50 to continue rotating forward.

In second state, when the permanent magnet 28 attracts the rotor 50 to drive the rotor 50 to rotate, the conduction coil L2 generates a induced signal, such as a conduction voltage. When the control device 720 receives the induced signal, the transistor Q2 is turned on. The DC current Vdc flows through the power coil L1. The outer layers of the salient poles A and B of the stator are conducted to be N-pole again, and the poles C and D of the stator are conducted to be S-pole again. Due to the magnetic force of the poles C and D being greater than that of the permanent magnet 28, the rotor 50 is driven by an attraction force between the poles C and D and the poles Sa and Sb to continue rotating forward in the same direction.

In third state, when the salient poles C and D attract the rotor 50 to drive the rotor 50 to rotate, the salient poles C and D and the permanent magnet 28 are magnetically opposite, and thus the conduction coil L2 generates a reverse induced signal, such as a reverse conduction voltage. Therefore, the reverse base-emitter voltage of the transistor Q2 is below the junction voltage, so the transistor Q2 is turned off.

When the transistor Q2 is turned off, no current flows through the power coil L1. The conducted magnetic field of the stator disappears, and the rotor 50 continues rotating forward in the same direction. Thus, return to the first state.

The torque of the rotor 50 is provided half by the conducted magnetic field generated by the power coil L1 and half by the permanent magnet 28.

Similar operations can be derived for the driver 700 used in the brushless DC motor in FIG. 2.

The voltage detection device 730 detects the induced signal. When the rotor 50 rotates, the brushless DC motor operates in the first, the second, and the third state alternately. The conduction coil L2 generates the conduction voltage and the reverse conduction voltage alternately, so the transistor Q3 is turn on and off alternately. Thus, a high-low signal is generated, for example a square wave pulse signal. After calculation, the rotational speed of the rotor 50 can be obtained. The high-low signal can be a voltage signal or a current signal. An extra DC current Vcc can be added in the voltage detection device 730 to control a high-low rate of an output voltage.

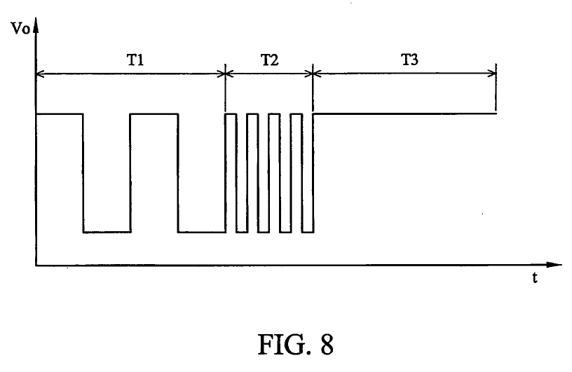

FIG. 8 is an output voltage to time graph when a brushless DC motor rotates. The horizontal axis represents time t, and the vertical axis represents output voltage Vo. The wave corresponding to T1 is the output wave when the rotational speed of the rotor 50 becomes slow due to dust or other objects. The wave corresponding to T2 is the output wave when the rotor 50 operates normally. The wave corresponding to T3 is the output wave when the rotor 50 stops rotating.

When the rotor 50 stops rotating, the conduction coil L2 stops generating the conduction voltage, the transistors Q1, Q2, and Q3 are all turned off. Thus, no undesired current flows into the power coil L1, the transistors Q1, Q2, and Q3, and the conduction coil L2.

In some embodiments of a brushless DC motor, when the rotor 50 stops rotating, no undesired current flows into any active component or coil of the driver, preventing overheating or burn-out. Any malfunctions can be easily eliminated by coupling the brushless DC motor to the DC current Vdc again, to restore operation.

Thus, the disclosed driving device 700 can potentially stabilize the brushless DC motor.

The start-up device 710 further comprises a releaser comprising a diode D1 and a resistor R2. When the start-up device 710 is disconnected from the DC current Vdc, the releaser releases electric power stored in the capacitor C by discharging the capacitor C through the diode D1 and the resistor R2. Thus, the capacitor C is re-charged when the start-up device 710 is again coupled to the DC current Vdc.

An embodiment of the stator structure is appropriate for a motor or a fan with coils axially or radially wound thereon.

While the invention has been described by way of example and in terms of several embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A brushless direct current motor, comprising:
a rotor, comprising a plurality of magnetic poles; and
a stator, coupled to the rotor, wherein the stator comprises a plurality of salient poles corresponding the magnetic poles, and at least one permanent magnetic element disposed on at least one salient pole to produce an auxiliary magnetic field on a corresponding salient pole to rotate the rotor.

2. The brushless direct current motor as claimed in claim 1 further comprising a driver connected to the stator for providing a primary magnetic field to drive the rotor, wherein the primary magnetic field and the auxiliary magnetic field alternately drive the rotor.

3. The brushless direct current motor as claimed in claim 2, wherein the driver comprises:
a first coil wound around the stator, for detecting a rotation of the rotor and generating an induced signal;
a start-up device for providing a start-up signal when the driver receives a power; and
a control device electrically connected to the first coil and the start-up device for receiving the start-up signal and the induced signal, wherein the control device determines whether to produce the primary magnetic field according to the induced signal and the start-up signal.

4. The brushless direct current motor as claimed in claim 2, wherein the driver further comprises a second coil wound around the stator and electrically connected with the control device, and when the control device receives the induced signal and the start-up signal, the control device outputs a control signal to the second coil enable the stator to generate a primary magnetic field.

5. The brushless direct current motor as claimed in claim 4, the control device comprising a first transistor electrically connected between the first coil and the second coil, wherein the second coil receives the control signal when the transistor is turned on by the induced signal.

6. The brushless direct current motor as claimed in claim 3, the start-up device further comprising a storage circuit and a releaser, wherein the storage circuit controls the output of the start-up signal by a stored energy in the storage circuit when the control device is coupled to the power; and the releaser is coupled to the storage circuit for releasing the stored energy when the start-up device is not coupled to the voltage or the current of the power.

7. The brushless direct current motor as claimed in claim 3, the driver further comprising a detection device electrically connected to the first coil, wherein the detection device outputs a rotation information of the rotor according to the induced signal.

8. The brushless direct current motor as claimed in claim 1, wherein each salient pole comprises at least one magnetically permeable element, and the permanent magnetic element is disposed above, below the magnetically permeable element or sandwiched by two of the magnetically permeable elements.

9. The brushless direct current motor as claimed in claim 1, wherein when the permanent magnetic element is disposed on one of the salient poles, a hole, a non-magnetically permeable element or a magnetically permeable element is correspondingly located on the permanent magnetic element.

10. The brushless direct current motor as claimed in claim 9, wherein the material of the non-magnetically permeable element is plastic.

11. The brushless direct current motor as claimed in claim 9, wherein the material of the magnetically permeable element is a magnetic iron or a soft magnetic.

12. The brushless direct current motor as claimed in claim 1, wherein the permanent magnetic element is a rubber magnet, a plastic magnet or a plastic covered magnet.

13. The brushless direct current motor as claimed in claim 1, wherein the auxiliary magnetic fields of the permanent magnetic elements on the opposite salient poles have the same polarity, and the auxiliary magnetic fields on the neighboring salient poles have the different polarities.

14. The brushless direct current motor as claimed in claim 1, wherein the auxiliary magnetic field is a north pole or a south pole.

15. A driver for a brushless direct current motor which comprises a primary magnetic field and a auxiliary magnetic field, comprising:
a first coil wound around the stator, for detecting a rotation of the rotor and generating an induced signal;
a start-up device for providing a start-up signal when the driver receives a power; and
a control device electrically connected to the first coil and the start-up device for receiving the start-up signal and the induced signal, wherein the control device determines whether to produce the primary magnetic field according to the induced signal and the start-up signal.

16. The driver as claimed in claim 15, wherein the driver further comprises a second coil wound around the stator and electrically connected with the control device, and when the control device receives the induced signal and the start-up signal, the control device outputs a control signal to the second coil to enable the stator to generate a primary magnetic field.

17. The driver as claimed in claim 15, the control device comprising a first transistor electrically connected between the first coil and the second coil, wherein the second coil receives the control signal when the transistor is turned on by the induced signal.

18. The driver as claimed in claim 15, the start-up device further comprising a storage circuit and a releaser, wherein the storage circuit controls the output of the start-up signal by a stored energy in the storage circuit when the control device is coupled to the power; and the releaser is coupled to the storage circuit for releasing the stored energy when the start-up device is not coupled to the voltage or the current of the power.

19. The driver as claimed in claim 15, the driver further comprising a detection device electrically connected to the first coil, wherein the detection device outputs a rotation information of the rotor according to the induced signal.

20. The driver as claimed in claim 15, wherein the auxiliary magnetic field is a permanent magnetic, a rubber magnet, a plastic magnet or a plastic covered magnet.
